(19) United States
(12) Patent Application Publication
(10) Pub. No.: US 2025/0209548 A1
(43) Pub. Date: Jun. 26, 2025

(54) TRANSFORMER CONNECTION MAPPING IN AN OPERATING ELECTRIC POWER GRID

(71) Applicant: X Development LLC, Mountain View, CA (US)

(72) Inventors: Arthur Robert Pope, Palo Alto, CA (US); Xinyue Li, San Mateo, CA (US)

(21) Appl. No.: 18/396,278

(22) Filed: Dec. 26, 2023

(51) Int. Cl. G06Q 50/06; G06Q 10/04; G06Q 10/0631

(52) U.S. Cl. CPC G06Q 50/06; G06Q 10/04; G06Q 10/06315

(57) ABSTRACT

Methods, systems, and apparatus, including medium-encoded computer program products, for transformer connection mapping in an operating electric power grid. The system can determine that a first utility meter is fed by a transformer in an electrical power distribution network based on a geographic distance between the first utility meter and the transformer as determined from non-electrical data. The system can obtain first electrical measurements from the first utility meter at predetermined time intervals and second electrical measurements from a second utility meter at the predetermined time intervals. The system can determine a likelihood that the second utility meter is fed by the transformer by, at least, performing a time-based correlation between the first electrical measurements and the second electrical measurements within a predefined time window. The system can associate a load supplied through the second utility meter with the transformer in a computer model of the electrical power distribution network.

### TECHNICAL FIELD

This specification relates to techniques for determining electrical connections between distribution transformers and electrical meters within an operating electrical grid and using such determinations to update electrical grid models.

### BACKGROUND

Electrical power grids are interconnected networks of power sources, power loads, and power delivery and regulating components. Distribution transformers are electrical components that transfer electrical current from an electrical circuit to one or more other electrical circuits and can step down voltage for delivery to loads such as homes and businesses. Electrical meters measure electricity flowing between the distribution transformer and an electrical load.

### SUMMARY

This specification describes techniques for enhancing grid models by determining connections between distribution transformers and electrical meters. The techniques can include determining an initial, or “seed,” connection between a meter and a distribution transformer, and using the seed to predict connections between other meters and the distribution transformer.

Particular embodiments of the subject matter described in this specification can be implemented so as to realize one or more of the following advantages. The techniques described below can be used to improve the accuracy of electrical grid models by determining connections between distribution transformers and meters. Accurate grid models enable optimal feeder and asset capacity planning, improve the serviceability of the grid and enable more efficient recovery when components of the grid degrade or become inoperable. In addition, accurate grid models can be used in grid simulations, which can improve reliability and efficiency when adding distributed energy sources, such as solar and batteries. Thus, the techniques of this specification help address climate change by encouraging the addition of renewable energy sources.

In general, innovative aspects of the subject matter described in this specification can be embodied in methods that include the actions of: determining that a first utility meter is fed by a transformer in an electrical power distribution network based on a distance between the first utility meter and the transformer as determined from non-electrical data; obtaining first electrical measurements from the first utility meter at predetermined time intervals; obtaining second electrical measurements from a second utility meter at the predetermined time intervals; determining a likelihood that the second utility meter is fed by the transformer by, at least, performing a time-based correlation between the first electrical measurements and the second electrical measurements within a predefined time window; and associating a load supplied through the second utility meter with the transformer in a computer model of the electrical power distribution network. Other implementations of this aspect include corresponding systems, apparatus, and computer programs, configured to perform the actions of the methods, encoded on computer storage devices.

These and other implementations can each optionally include one or more of the following features. In some implementations, associating the load supplied through the second utility meter with the transformer includes associating the load supplied through the second utility meter with the transformer based, at least in part, on the likelihood satisfying a threshold value.

In some implementations, determining that the first utility meter is fed by the transformer in the electrical power distribution network is based on the distance between the first utility meter and the transformer as determined from non-electrical data includes comparing image cues.

In some implementations, determining that the first utility meter is fed by the transformer in the electrical power distribution network is based on the distance between the first utility meter and the transformer as determined from non-electrical data includes comparing geospatial cues.

In some implementations, determining the likelihood that the second utility meter is fed by the transformer includes determining that a distance between the first utility meter and the second utility meter satisfies a threshold.

Some implementations include the actions of: determining, for each utility meter within a set of utilities meters, a likelihood that the meter is fed by the transformer by, at least, performing a time-based correlation between the first electrical measurements and individual electrical measurements from each utility meter in the set, each individual electrical measurement taken within a predefined time window, ranking, each utility meter in the set based on its respective likelihood, and for at least one of the utility meters in the set, associating a second load supplied through the at least one of the utility meters with the transformer based on the ranking.

Some implementations include the actions of: determining that a third utility meter is fed by a second transformer in the electrical power distribution network based on a distance between the third utility meter and the second transformer as determined from non-electrical data; obtaining third electrical measurements from the third utility meter at third predetermined time intervals; obtaining fourth electrical measurements from a fourth utility meter at the third predetermined time intervals; determining a second likelihood that the third utility meter is fed by the second transformer by, at least, performing a time-based correlation between the third electrical measurements and the fourth electrical measurements within a predefined time window; and responsive to the second likelihood exceeding the likelihood, associating a fourth load supplied through the fourth utility meter with the second transformer in the computer model of the electrical power distribution network.

In some implementations, the predetermined time intervals include a first duration of a measurement duration, and the measurement duration can exceed the first duration. In some implementations, the first duration does not exceed 10% of the measurement duration.

In some implementations, the first utility meter is an AMI meter. The details of one or more embodiments of the subject matter described in this specification are set forth in the accompanying drawings and the description below. Other features, aspects, and advantages of the invention will become apparent from the description, the drawings, and the claims.

### BRIEF DESCRIPTION OF THE DRAWINGS

FIG. 1 shows an example of an environment for determining connections between distribution transformers and meters.

FIG. 2A is a flow diagram of an example process for determining connections between distribution transformers and meters.

FIG. 2B shows an example process for determining meter/transformer associations for unknown meters.

FIG. 2C shows an example of the process described in reference to FIG. 2B.

FIG. 3A shows an example of clustering electrical data.

FIG. 3B illustrates voltage correlations.

FIG. 4 is a block diagram of an example computer system.

Like reference numbers and designations in the various drawings indicate like elements.

### DETAILED DESCRIPTION

Electrical power grids are interconnected networks of power sources, power loads, and power delivery and regulating components. The delivery of electricity over a power grid can include transmission, which typically occurs at high voltage and over large distances, and distribution, which typically occurs at lower voltage and over shorter distances. For example, a power plant can generate electricity, which is then stepped up to high voltage for long distance transmission, and then stepped down at substations for low voltage distribution by distribution transformers. The distribution system can then distribute power from distribution transformers to loads such as local homes and businesses. The power distributed to such loads flows through power meters which measure the electricity delivered to a load. In common usage, loads are typically understood to use electrical energy, rather than supplying electricity to the power grid. However, recent increases in distributed energy power sources (DEPS), such as solar power systems and battery systems, typical electric grid loads (e.g., homes, businesses, etc.) may supply electricity to the electric grid for periods of time when a DEPS generates more electricity than the load requires.

Electrical power grids include a broad range of interconnected components that can deliver power from power generation to loads such as homes and businesses. Some elements, such as substations, participate in both transmission and distribution. The components can be of various types such as inverters (Solar, Wind, HVDC, etc.), relays, Power Plant Controllers (PPCs), Energy Management Systems, Remedial Action Systems (RAS), Automatic Generator Controls, alarm systems and so on.

The operation of one component often influences the operation of other components. For example, a PPC regulates and controls networked inverters within a power plant. In addition, various components can operate differently under different load conditions. Further, the output of one component can influence the load of other components. Understanding how the totality of components in the grid operate can aid in proper grid operation.

Simulations can be used to estimate how various components will operate under such varying load conditions. The model used for simulation can be called a power grid model (or “grid model,” for brevity), which can operate on a grid model or on a subset of a grid model. For example, a grid model can include connections between a distribution transformer and electrical meters that measure electricity flowing from the distribution transformer to a load. A grid model also enables troubleshooting as abnormal behavior detected at one component can be traced through the model to locate a faulty component, which is not necessarily the component at which the fault is detected.

A grid model can span the totality of components from generators to end loads (e.g. households, businesses, factories, etc.). A model can be a software representation (e.g., text, code, or other computer data structure representation) of power system components and electrical networks that can include mathematical representations of the components used for simulation and analysis. Physical components of the electrical grid can be represented by elements of the grid model, and simulations can be performed on such grid models.

One type of meter is an advanced metering infrastructure (AMI) meter. AMI is an integrated system of smart meters, communications networks, and data management systems that enables two-way communication between utilities and customers. The core elements of AMI are smart meters, which are installed at electrical customers and provide a variety of functions. The most used function is energy consumption (kWh) measurement for billing and time-based rates. Some AMI smart meters can also measure or detect voltage (V), real power (KW), reactive power (kVAr), phase, power factor, outage, etc. in various temporal resolutions. Since AMI meters can provide data describing electrical properties at the meter, the techniques of this specification can use such data to identify the connections between distribution transformers and meters.

Accurate simulation requires an accurate grid model, including representations of the connections between distribution transformers and loads, such as the local homes and businesses, which are connected to the distribution transformers. However, accurate data for such connections are often not available or are incorrect, and therefore grid models can be incomplete, which can limit the accuracy of simulations.

Accurate grid models are also important to maintenance and repair of electrical components, including troubleshooting. For example, if a distribution transformer will be taken off-line for maintenance, or goes off-line due to a failure, an accurate grid model will reflect the loads impacted by the loss of the transformer. Similarly, if a report of a power outage is received from a household, an accurate grid model can be used to determine the distribution transformer which might be malfunctioning. Accurate grid models are further important for distribution systems analysis, asset maintenance, and capacity planning. For example, effective demand response management, Volt/VAR optimization (VVO), transformer loading monitoring and capacity analysis all require accurate grid models.

This specification describes techniques for enhancing grid models by determining connections between distribution transformers and loads. The techniques include initially determining connections between seed meters and distribution transformers, and using those seeds to identify other connections between meters and distribution transformers.

Using such predictions to develop an accurate grid model is important for many reasons, including integration of distributed energy resources (e.g., solar inverters, battery storage, electric vehicles, and smart thermostats among many other examples) and human safety. For example, if a distributed energy source is added to the grid, power companies must ensure that connected distribution transformers will not become overloaded or unstable. In another example, if an outage is predicted to occur, an accurate grid model enables a power company to inform impacted customers, and to make provisions for customers for which uninterrupted power is essential.

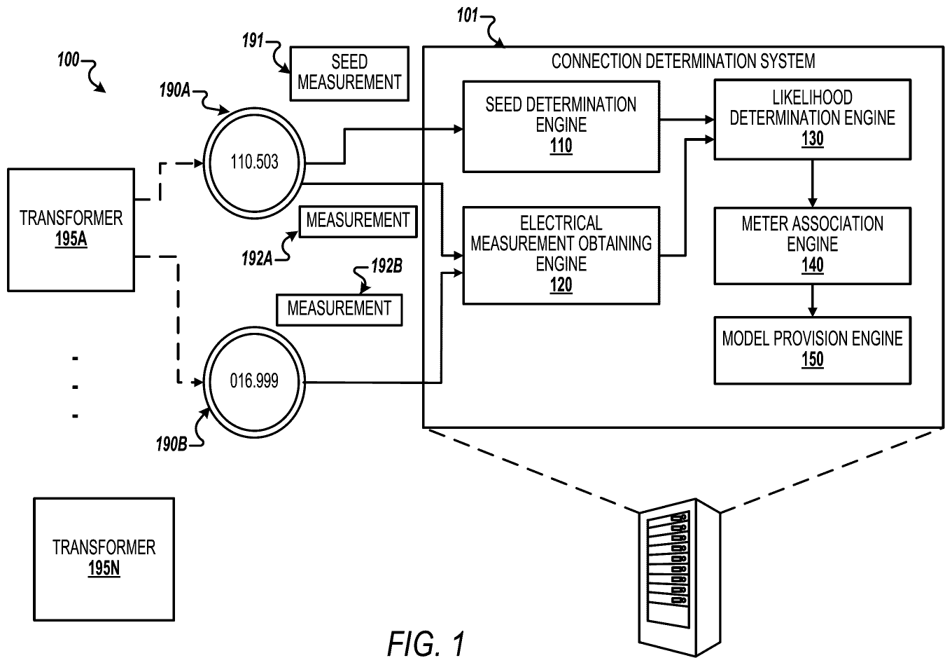

FIG. 1 shows an example of an environment for determining connections between distribution transformers and meters. The environment can include distribution transformers 195A, 195N (collective referred to as “transformers 195” for brevity), electrical meters 190A, 190B (collectively referred to as “electrical meters 190,” or, for brevity, “meters 190”) that are fed by transformers 195 and a connection determination system 101.

Transformers 195 are electrical components that transfer electrical current from an electrical circuit to one or more other electrical circuits. Transformers can further step up and/or step down voltage. For example, a transformer can step down voltage from a distribution line (e.g., 4.8 kilovolts, 6.9 kilovolts, 13.8 kilovolts, etc.) to a household, business or other electrical load household (e.g., 120 volts).

Electrical meters 190 can measure properties of electricity delivered to an electrical load. For example, an electrical meter 190 can measure current (e.g., in amperes or “amps”) and voltage (e.g., in volts) to determine the energy used (e.g., expressed in joules or kilowatt-hours). Electrical meters 190 can take various forms, including analog and digital, such as smart meters.

Smart meters can implement the advanced metering infrastructure (AMI) standard, and such meters 190 can be called “AMI meters.” AMI enables two-way communication, allowing monitoring systems, such as the connection determination system 101, to receive monitored data in real-time or near real-time.

The connection determination system can include a seed determination engine 110, an electrical measurement obtaining engine 120, a likelihood determination engine 130, a meter association engine 140 and a model provision engine 150.

The seed determination engine 110 can determine an association between a transformer 195 and a meter 190. The seed determination engine 110 can receive information, which can be called “seed measurements” 191, that describe relationships between transformers 195 and meters 190. In various implementations, the seed determination engine 110 can obtain a seed measurement 191 that includes, in any combination, (i) the distance between meters 190 and one or more transformers; (ii) the locations of the meters 190 (e.g., as specified as latitude, longitude pair or other suitable specifications) and of one or more transformers 195; (iii) image data from which location can be determined; (iv) other types of location data; (v) electrical data; and (vi) other descriptive data. The seed determination engine 110 can obtain the seed measurements 191 from a database containing geospatial information (e.g., distance, location, image data, etc.). For example, the seed determination engine 110 can obtain seed measurements 191 by providing an Application Programming Interface (API) that enables the seed determination engine 110 to receive such information, and/or by using other suitable techniques.

In some implementations, the seed determination engine 110 can receive one or more seed measurements 191 that include geospatial cues (e.g., how the meter and transformer are positioned with respect to nearby roads and casements), image cues (e.g., whether there are poles or wires visible between meter and transformer), and other datasets (e.g., of underground utility line locations) in addition to, or instead of, distance information. Using some or all of the received information, the seed determination engine 110 can then determine that a meter 190 is fed by a particular transformer 195. The seed determination engine 110 can provide information about that association to the likelihood determination engine 130.

The seed determination engine 110 can determine seed meters for multiple transformers. The seed determination engine 110 can receive seed measurements 191 for multiple meters 190 and multiple transformers 195, and for each transformer 195, determine associations between the transformer 195 and a meter 190 that will serve as a seed for the transformer 195. In some implementations, the seed determination engine 110 can determine multiple seed meters for the same transformer.

The seed determination engine 110 can determine the seed meter as being the meter that is the shortest distance from the transformer. For example, the seed determination engine 110 can obtain the location of each unassigned meter and the location of the transformer for which a seed meter is to be computed. The seed determination engine 110 can then compute the distance (e.g., Euclidean or Haversine) between the transformer and each unassigned meter, and determine that the transformer feeds the meter that is the shortest distance from the transformer, which the seed determination engine 110 can identify as the seed meter for that particular transformer.

The electrical measurement obtaining engine 120 can receive electrical measurements 192A, 192B (collectively referred to as “electrical measurements 192,” or for brevity, “measurements 192”) from meters 190. Measurements 192 can include electrical properties such as voltage levels, amperage (e.g., current), and power consumption. Measurements 192 can reflect measurements taken continuously and/or at discrete intervals. Measurements 192 can further include outages. In some implementations, measurements 192 can further include non-electrical properties such as temperature, rainfall, humidity, barometric pressure, etc. The electrical measurement obtaining engine 120 can receive measurements 192A from the seed meter 190 and measurements 192B from unassigned meters—that is, meters for which the system is determining transformers. The electrical measurement obtaining engine 120 can provide the measurements 192 to the likelihood determination engine 130.

The likelihood determination engine 130 can determine the likelihoods that a meter is associated with each of one or more transformers and can use both the measurements 192 and the seed association or associations (if multiple seeds are assigned). As described further below, the likelihood determination engine 130 can compare measurements from the seed meter 190 and from the target meter 190 to determine whether a meter 190 is associated with (e.g., fed by) a transformer 195. For example, the likelihood determination engine 130 can perform a time-based correlation between electrical measurements received from the seed meter 190 and electrical measurements received from an unassigned meter 190. The similarity between the measurements 192A from the seed meter 190 and measurements 192B from the unassigned meter(s) can be used to determine a likelihood that the unassigned meter is associated with (e.g., fed by) the same transformer as the seed meter. The likelihood determination engine 130 can provide the determined likelihoods between meters 190 and transformers 195 to the meter association engine 140.

The meter association engine 140 can use the determined likelihoods to associate meters 190 with transformers 195. As described further below, the meter association can, for example, associate the meter 190 with the transformer 195 having the highest likelihood of association. In some examples, the highest likelihood of association can be determined based on the target meter 190 who's electrical measurements 19 most closely correlate with those of the seed meter 190. The meter association engine 140 can update a model of an electrical grid to include the determined associations. The model provision engine 150 can then provide the updated model to entities authorized to access the model.

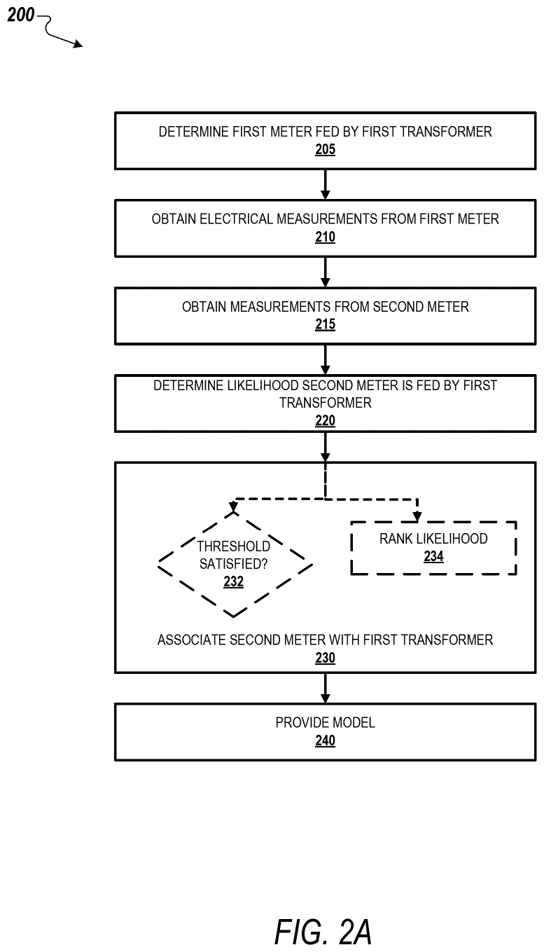

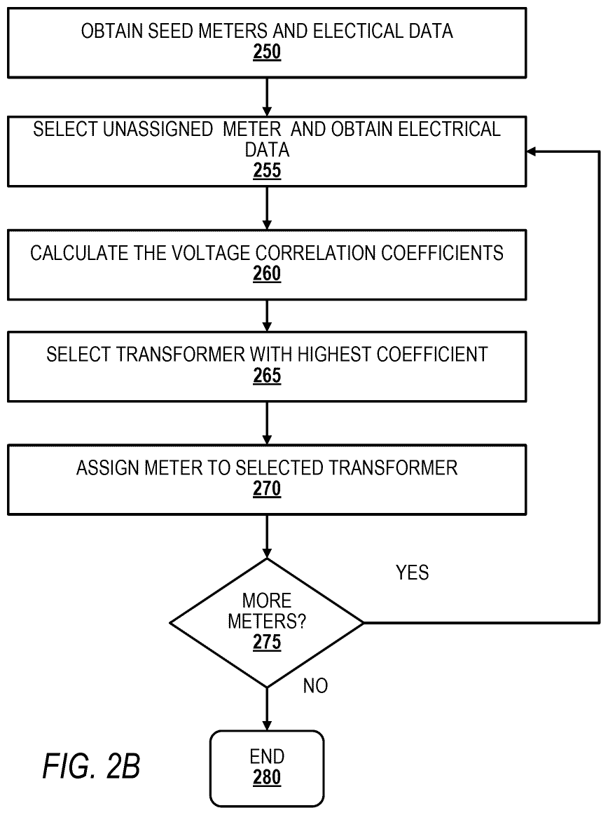

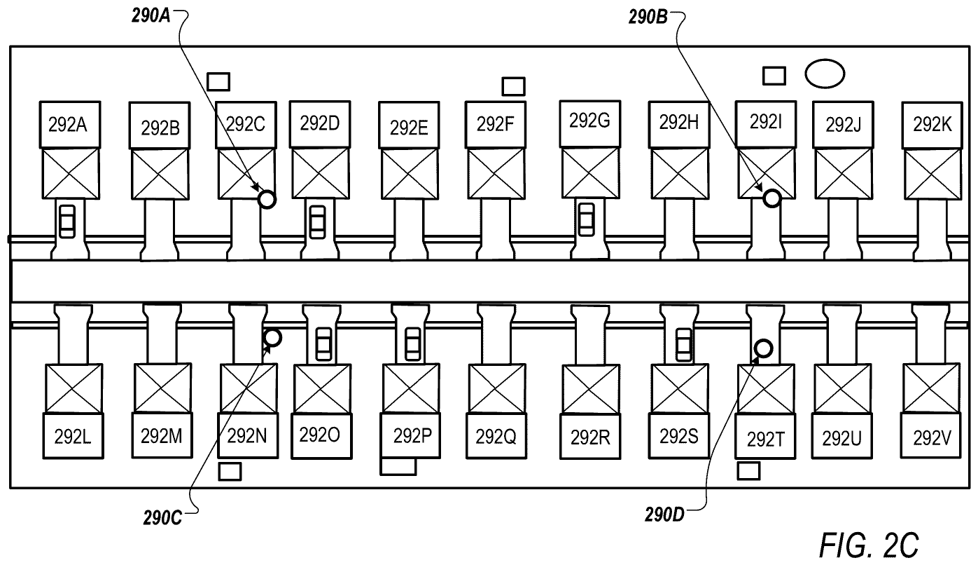

FIG. 2A is a flow diagram of an example process for determining connections between transformers and meters. For convenience, the process 200 will be described as being performed by a system for determining connections between transformers and meters, e.g., the connection determination system 101 of FIG. 1, appropriately programmed to perform the process. Operations of the process 200 can also be implemented as instructions stored on one or more computer readable media which may be non-transitory, and execution of the instructions by one or more data processing apparatus can cause the one or more data processing apparatus to perform the operations of the process 200. One or more other components described herein can perform the operations of the process 200.

The system determines (205) that a first, seed utility meter is fed by a transformer in an electrical power distribution network. The determination can be based on a geographic distance between the first utility meter and the transformer as determined from non-electrical data. In some implementations, the system obtains data describing the distance between the transformer and each meter that has not been assigned to a transformer—that is, unassigned meters. The system can determine the seed meter as being the meter that is the shortest distance from the transformer.

In some implementations, the system can obtain the location of each unassigned meter and the location of the transformer for which a seed meter is to be computed. The system can then compute the distance between the transformer and each unassigned meter, and determine that the transformer feeds the meter that is the shortest distance from the transformer, which the system can identify as the seed meter.

In some implementations, the system can determine multiple seed meters for a transformer. For example, the system can assign to the transformer a configured number, N, of seed meters, such as the N closest meters to the transformers. In another example, the system can assign as the seed meter the meter that is closest to the transformer, and further assign all meters that are within a configured distance of the transformer and/or within a configured distance of the seed.

In some implementations, the system can compare geospatial cues in an image. For example, the system can obtain image data (e.g., a “streetview map”), and use the image data that contains image cues (e.g., the presence of a transformer and a house that is associated with the meter within the same “streetview” image) to compute the distances. In this example, the system can use object detecting techniques to identify a transformer and multiple meters within an image, and determine the distance between the transformer and each identified meter. Continuing the example, the system can compute the Euclidean distances (or other distance metrics) between the point in the image identified as the transformer (as noted above, other distance metrics can be used), and the points in the image representing each meter.

In some implementations, the system can obtain image data, and determine the association between an unassigned meter and the transformer using cues in the image. For example, the system can use object recognition to determine that a power line exists in the image between a transformer and one or more unassigned meters, and assign the meter(s) as the seed(s).

In some implementations, the system can obtain various combinations of data that can be used to determine distance. For example, the system can receive the distance between some unassigned meters and the transformer, and the location of some unassigned meters. In this example, the system can compute the Euclidean distances for which the system obtained the location (instead of the distance), and use the shortest distance to select a seed meter, as described above. In cases where the distances are specified in different units, the system can perform a unit conversion.

The seed associations are then extended to the remaining meters, in some implementations, by comparing electrical measurements, such as voltages. Since the loads are connected in parallel, meters served by the same distribution transformer have similar voltage measurements. Such similarity results in the correlation of voltage measurements of meters associated with the same distribution transformer being higher than correlations with those associated with different transformers.

To determine such associations, once the seeds have been determined, the system can obtain electrical measurements from utility meters in the set of seed meters and from utility meters not in the set of seed meters (unassigned meters), e.g., at predetermined time intervals. As described above, AMI meters provide two-way communication, enabling the meters to provide the electrical measurements either directly to the system, or indirectly. Indirectly can include providing the measurements to an intermediate system (or systems) which provide the data to the system, and/or by storing the measurements in a data repository (e.g., a database or file system) from which the system can obtain the measurements.

Regardless of whether the measurements are provided directly and/or indirectly, the system obtains (210) first electrical measurements from a seed utility meter (e.g., first meter) at predetermined time intervals, and obtains (215) second electrical measurements from an unassigned meter at the predetermined time intervals. Such time intervals can be a portion of a measurement interval, such a configured number of minutes in a measurement interval (e.g., the first one minute, the first five minutes, minutes five to ten, the last five minutes of an interval, and so on). Such time intervals can also be a percentage of the measurement intervals (e.g., the first 5% of the interval, the first 10% of the interval, the last 10% of the interval, etc.).

The system determines (220) a likelihood that the unassigned utility meter is fed by the transformer that is feeding the seed meter, at least in part, by performing a time-based correlation between the first electrical measurements and the second electrical measurements. The correlation can be determined within a predefined time window. The system can obtain electrical measurements from the seed meter and at the unassigned meter taken in close temporal proximity, e.g., within a predefined time window. Then, to determine whether a non-seed meter is served by the same distribution transformer as a seed meter, the system can compare voltages reading at the non-seed meter to those at the seed meter, e.g., by computing a correlation coefficient.

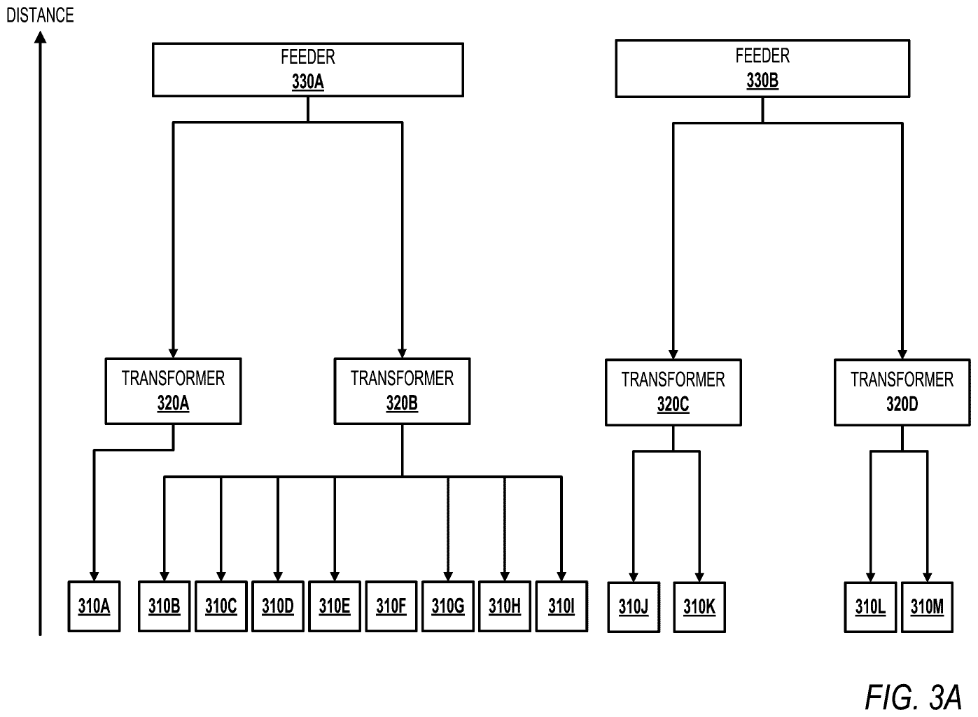

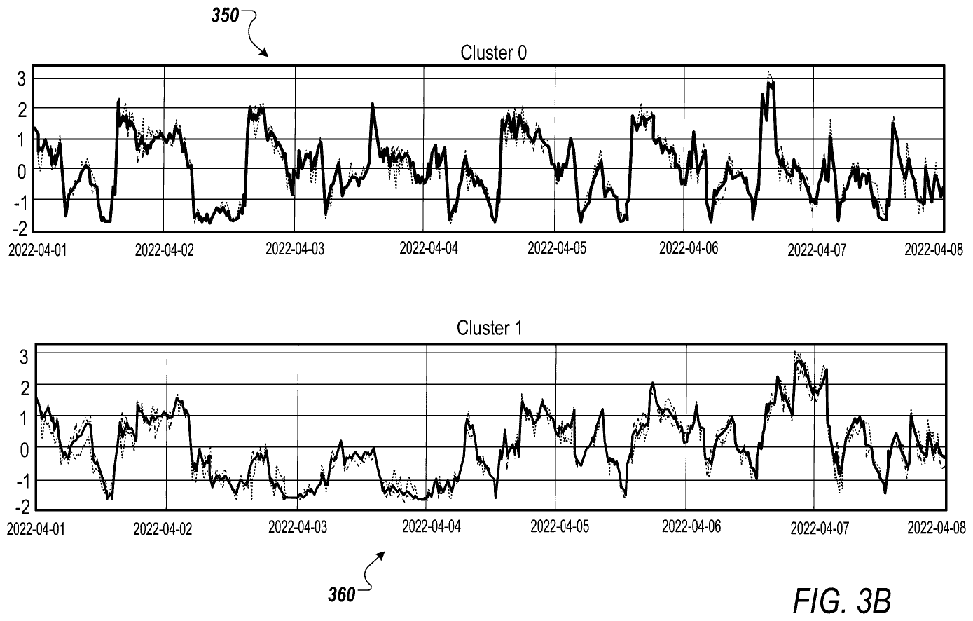

In general, electrical measurements at meters fed by the same transformer will be similar, and these meters can be assigned to a cluster of meters fed by the transformer. For example, FIG. 3A shows an example of clustering electrical data. Specifically, FIG. 3A shows a clustering dendrogram created using voltage measurements from fifteen (15) meters (310A-3100) associated with different transformers (320A-320D) on two feeders (330A, 330B). There are nine meters (310A-3101) on feeder 330A, with eight meters served (meters 330B-330I) by one transformer, transformer 320B, and one meter (meter 310A) served by a different transformer, transformer 320A. In this example, transformer 320A is across the street from transformer 320B.

The voltage measurements of the eight meters (meters 330B-330I) associated with transformer 320B will be more similar to each other than they will be to measurements taken at other meters (e.g., meters associated with transformer 320A, transformer 320C or transformer 320D), therefore the likelihood that other meters in the cluster (e.g., meters 330C-330I) are fed by the transformer (e.g., transformer 320B, in this example) that is feeding the seed meter (e.g., meter 330B) will be high, and are thus the meters grouped into the same cluster.

FIG. 3B illustrates voltage correlations. The normalized voltage time series is plotted for each cluster (cluster 350, cluster 360), where each meter in a cluster is served by the same transformer. As is apparent from the example, the shapes of time series in the same cluster will be more similar to each other than to the time series for the other cluster. Therefore, the correlation coefficient for data from meters served by the same transformer will be higher than correlation coefficients for data from meters served by different transformers.

In some implementations, the system can compare voltages by determining a time-based correlation of voltage values (e.g., a correlation coefficient), and the correlation can be used to determine the likelihood. For example, if the correlation is normalized (i.e., in the range −1 to 1), the likelihood can be the correlation. In another example, the likelihood can be the correlation truncated at zero, so likelihoods are always positive numbers. In another example, the normalized correlation can be projected into a probability, e.g., by adding one to the correlation and dividing by two or using other suitable projection techniques. Other techniques for determining likelihood from correlation can also be used.

The system then associates (230) the unassigned meter with the first transformer. In some implementations, the system can compare the likelihood that the unassigned utility meter is fed by the transformer to a threshold value. If the likelihood satisfies (232) the threshold value, the system can associate the unassigned meter with the transformer, and associate a load supplied through the unassigned utility meter with the transformer in a computer model of the electrical power distribution network.

In some implementations, the system can determine seed meters for multiple distribution transformers, then perform time-based correlations (e.g., as described above) between an unassigned meter and seed meters associated with different distribution transformers. The system can associate the load supplied by the meter with a given distribution transformer based on comparisons between time-based correlations between loads detected at the meter and load detected at seed meters associated with various distribution transformers.

In some implementations, the system can rank (234) the likelihoods that a meter is associated with each transformer by correlating the load at the seed meter with the load at seed meters associated with each of the transformers. The system can then use the correlation to determine likelihoods, e.g., using the techniques described above. The system can associate the meter with the distribution transformer for which the likelihood is highest, or with the distribution transformer for which the likelihood is both highest and exceeds a configured threshold.

When determining associations, the system can use distance in addition to, or instead of, a time-based correlation. For example, the system can associate the load from a meter with a distribution transformer if the likelihood exceeds a threshold, but only if a geographic distance satisfies a distance threshold (e.g., is within a threshold distance). In another example, if the distance is below a particular threshold (e.g., within a certain distance), the system can associate the load from the meter with the distribution transformer without performing the time-based correlation. Such an approach can reduce the computational resources needed to complete the computation.

In some implementations, when the system determines that the likelihood satisfies a threshold value (e.g., the likelihood exceed 75%, 80%, 85%, etc.), the system can update a computer model of the electrical power distribution network with an association of the load supplied by the utility meter with the distribution transformer. In some implementations, the system can provide (240) the modified model. For example, the system can store the modified model in a database, or provide the modified model through a system API.

To further illustrate the techniques of this specification, FIG. 2B shows an example process for determining meter/transformer associations for unknown meters.

The system obtains (250) seed meters and electrical data for that meter, e.g., using the techniques of operation 205. The system selects (255) a first unassigned meter, Mᵢ, and obtains electrical data for that meter, e.g., using the techniques of operation 210.

The system calculates (260) the voltage correlation coefficient Mᵢ between unassigned meter M and the N seed meters that are in closest proximity to meter Mᵢ, N can be a configured constant or it can be variable. For example, the system can use all seed meters within a predefined distance (e.g., 100 feet) from the unassigned meter. In another example, the distance can be variable, such as one distance in an urban environment (e.g., 60 feet, 70 feet, 80 feet, etc.) and another distance in rural areas (e.g., 140 feet, 150 feet, 160 feet, etc.)

In some implementations, the system can use a fixed duration voltage time series for the coefficient calculation and perform operations (255) and (260) a single time. The duration can be 1 day, 1 week, or 1 month, etc. The duration can be tuned depending on sensor sampling resolution, voltage variability, and so on.

In some implementations, the system can use a rolling window, and perform operations (255) and (260) for N times but over different periods. Note that a meter might be associated with different transformers in different iterations. For example, associations can change when restoring service after an extreme weather event, to support load balancing, due to a capacity upgrade, etc.

The final association can be determined using various approaches. For example, the final association can be determined by the highest occurrence, e.g., if eight of ten iterations indicate an association between meters A and B, the system can determine that A and B are connected. In another example, the final association can be determined by a weighted average. For example, if the system determines confidence values of an association between meters A and B of {0.8, 0.6, 0.5, 0.7, 0.9} and between A and C of {0.2, 0.4, 0.5, 0.3, and 0.1} the sum of the confidence scores of an association between meters A and B exceed the sum of the confidence scores between meters A and C.

Using multiple iterations can increase accuracy and/or confidence. For example, if a given time interval is in a period when the loads are “quiet” (e.g., at night when no substantial changes in load occur and voltage fluctuation is small), the confidence of voltage correlations can be relatively weak, and noise can have a greater impact on results. In addition, if the loads remain unchanged within a selected interval, the voltage will not change (or will change minimally), creating a challenge to voltage-based correlation. In contrast, when using multiple intervals, especially when there are significant loading changes (e.g., a resident turns on a microwave oven or uses a kettle) in some of the intervals, the system will detect the voltages of connected loads moving similarly, increasing the confidence of the determined association.

The system selects (265) the transformer associated with the seed meter that produces the highest correlation coefficient. Note that the highest voltage correlation coefficient may still be low. Therefore, in some implementations, the system can set a threshold (e.g., 0.85, 0.9, 0.95, etc.). If the correlation satisfies the threshold, the system can denote the associations as high confidence, and denote the correlation as low confidence otherwise. For low confidence associations, additional techniques can be used to verify the association, such as field verifications.

The system assigns (270) the transformer associated with the seed meter that has the highest voltage correlation coefficient that is calculated with respect to Mᵢ.

The system can repeat the process until all the unknown meters are associated with transformers a transformer assignment by determining (270) whether there are additional unassigned meters, and if so, returning to operation 255. If there are no more unassigned meters, the process can end (280)

FIG. 2C shows an example of the process described in reference to FIG. 2B. FIG. 2C illustrates four service transformers 290A, 290B, 290C, 290D. FIG. 2C further includes AMI smart meters (292A-292V) connected to a load. AMI smart meters (292A-292V) are typically on, or close to, the dwelling. Using only a proximity-based approach, in one example, the seed meter/transformer associations with the highest confidence would be 292C/290A, 2921/290B, 292N/290C, 292T/290D as those associations have the minimum distance.

Once the seed meters have been determined, the unassigned meters can be assigned to transformers using the known seed meters. For example, if meter 292D is unknown, the system determines that the closest seed meters to 292D are meter 292C and meter 292N. The system can calculate the voltage correlation between meter 292D and meter 292C, and between meter 292D and meter 292N, respectively. If the voltage correlation between meter 292D and meter 292C is higher than that between meter 292D and meter 292N, the system assigns meter 292D to transformer 290A.

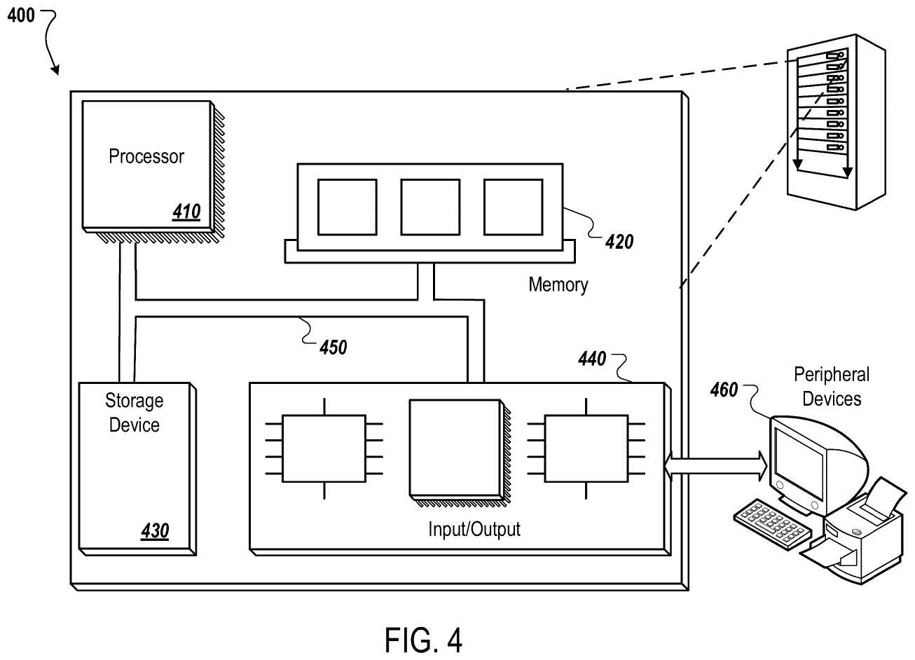

FIG. 4 is a block diagram of an example computer system 400 that can be used to perform operations described above. The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 can include, for example, a hard disk device, an optical disk device, a storage device that is shared over a network by multiple computing devices (e.g., a cloud storage device), or some other large capacity storage device.

The input/output device 440 provides input/output operations for the system 400. In one implementation, the input/output device 440 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 460. Other implementations, however, can also be used, such as mobile computing devices, mobile communication devices, set-top box television client devices, etc.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented using one or more modules of computer program instructions encoded on a computer-readable medium for execution by, or to control the operation of, data processing apparatus. The computer-readable medium can be a manufactured product, such as a hard drive in a computer system or an optical disc sold through retail channels, or an embedded system. The computer-readable medium can be acquired separately and later encoded with the one or more modules of computer program instructions, such as by delivery of the one or more modules of computer program instructions over a wired or wireless network. The computer-readable medium can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, a runtime environment, or a combination of one or more of them. In addition, the apparatus can employ various different computing model infrastructures, such as web services, distributed computing and grid computing infrastructures.

A computer program (also known as a program, software, software application, script, or code) can be written in any suitable form of programming language, including compiled or interpreted languages, declarative or procedural languages, and it can be deployed in any suitable form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, special purpose microprocessors. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM (Erasable Programmable Read-Only Memory), EEPROM (Electrically Erasable Programmable Read-Only Memory), and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

To provide for interaction with a user, embodiments of the subject matter described in this specification can be implemented on a computing device capable of providing information to a user. The information can be provided to a user in any form of sensory format, including visual, auditory, tactile or a combination thereof. The computing device can be coupled to a display device, e.g., an LCD (liquid crystal display) display device, an OLED (organic light emitting diode) display device, another monitor, a head mounted display device, and the like, for displaying information to the user. The computing device can be coupled to an input device. The input device can include a touch screen, keyboard and a pointing device, e.g., a mouse or a trackball, by which the user can provide input to the computing device. Other kinds of devices can be used to provide for interaction with a user as well; for example, feedback provided to the user can be any suitable form of sensory feedback, e.g., visual feedback, auditory feedback, or tactile feedback; and input from the user can be received in any suitable form, including acoustic, speech, or tactile input.

The computing system can include clients and servers. A client and server are generally remote from each other and typically interact through a communication network. The relationship of client and server arises by virtue of computer programs running on the respective computers and having a client-server relationship to each other. Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any suitable form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many implementation details, these should not be construed as limitations on the scope of what is being or may be claimed, but rather as descriptions of features specific to particular embodiments of the disclosed subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. Thus, unless explicitly stated otherwise, or unless the knowledge of one of ordinary skill in the art clearly indicates otherwise, any of the features of the embodiments described above can be combined with any of the other features of the embodiments described above.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and/or parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. For example, the actions recited in the claims can be performed in a different order and still achieve desirable results.

What is claimed is:

1. A computer-implemented method comprising:
determining that a first utility meter is fed by a transformer in an electrical power distribution network based on a distance between the first utility meter and the transformer as determined from non-electrical data;
obtaining first electrical measurements from the first utility meter at predetermined time intervals;
obtaining second electrical measurements from a second utility meter at the predetermined time intervals;
determining a likelihood that the second utility meter is fed by the transformer by, at least, performing a time-based correlation between the first electrical measurements and the second electrical measurements within a predefined time window; and
associating a load supplied through the second utility meter with the transformer in a computer model of the electrical power distribution network.

2. The computer-implemented method of claim 1, wherein associating the load supplied through the second utility meter with the transformer comprises associating the load supplied through the second utility meter with the transformer based, at least in part, on the likelihood satisfying a threshold value.

3. The computer-implemented method of claim 1, wherein determining that the first utility meter is fed by the transformer in the electrical power distribution network based on the distance between the first utility meter and the transformer as determined from non-electrical data comprises comparing image cues.

4. The computer-implemented method of claim 1, wherein determining that the first utility meter is fed by the transformer in the electrical power distribution network based on the distance between the first utility meter and the transformer as determined from non-electrical data comprises comparing geospatial cues.

5. The computer-implemented method of claim 1, wherein determining the likelihood that the second utility meter is fed by the transformer further comprises determining that a distance between the first utility meter and the second utility meter satisfies a threshold.

6. The computer-implemented method of claim 1 further comprising:
determining, for each utility meter within a set of utilities meters, a likelihood that the meter is fed by the transformer by, at least, performing a time-based correlation between the first electrical measurements and individual electrical measurements from each utility meter in the set, each individual electrical measurement taken within a predefined time window;
ranking, each utility meter in the set based on its respective likelihood; and
for at least one of the utility meters in the set, associating a second load supplied through the at least one of the utility meters with the transformer based on the ranking.

7. The computer-implemented method of claim 1 further comprising:
determining that a third utility meter is fed by a second transformer in the electrical power distribution network based on a distance between the third utility meter and the second transformer as determined from non-electrical data;
obtaining third electrical measurements from the third utility meter at third predetermined time intervals;
obtaining fourth electrical measurements from a fourth utility meter at the third predetermined time intervals;
determining a second likelihood that the third utility meter is fed by the second transformer by, at least, performing a time-based correlation between the third electrical measurements and the fourth electrical measurements within a predefined time window; and
responsive to the second likelihood exceeding the likelihood, associating a fourth load supplied through the fourth utility meter with the second transformer in the computer model of the electrical power distribution network.

8. The computer-implemented method of claim 1, wherein the predetermined time intervals comprise a first duration of a measurement duration, wherein the measurement duration exceeds the first duration.

9. The computer-implemented method of claim 8, wherein the first duration does not exceed 10% of the measurement duration.

10. The computer-implemented method of claim 1, wherein the first utility meter is an AMI meter.

11. A system comprising one or more computers and one or more storage devices storing instructions that when executed by the one or more computers cause the one or more computers to perform operations comprising:
determining that a first utility meter is fed by a transformer in an electrical power distribution network based on a distance between the first utility meter and the transformer as determined from non-electrical data;
obtaining first electrical measurements from the first utility meter at predetermined time intervals;
obtaining second electrical measurements from a second utility meter at the predetermined time intervals;
determining a likelihood that the second utility meter is fed by the transformer by, at least, performing a time-based correlation between the first electrical measurements and the second electrical measurements within a predefined time window; and
associating a load supplied through the second utility meter with the transformer in a computer model of the electrical power distribution network.

12. The system of claim 11, wherein associating the load supplied through the second utility meter with the transformer comprises associating the load supplied through the second utility meter with the transformer based, at least in part, on the likelihood satisfying a threshold value.

13. The system of claim 11, wherein determining that a first utility meter is fed by a transformer in an electrical power distribution network based on a distance between the first utility meter and the transformer as determined from non-electrical data comprises comparing image cues.

14. The system of claim 11, wherein determining that a first utility meter is fed by a transformer in an electrical power distribution network based on a distance between the first utility meter and the transformer as determined from non-electrical data comprises comparing geospatial cues.

15. The system of claim 11, wherein determining a likelihood that the second utility meter is fed by the transformer further comprises determining that a distance between the first utility meter and the second utility meter satisfies a threshold.

16. The system of claim 11, wherein the operations further comprise:
determining, for each utility meter within a set of utilities meters, a likelihood that the meter is fed by the transformer by, at least, performing a time-based correlation between the first electrical measurements and individual electrical measurements from each utility meter in the set, each individual electrical measurement taken within a predefined time window;
ranking, each utility meter in the set based on its respective likelihood; and
for at least one of the utility meters in the set, associating a second load supplied through the at least one of the utility meters with the transformer based on the ranking.

17. The system of claim 11, wherein the operations further comprise:
determining that a third utility meter is fed by a second transformer in the electrical power distribution network based on a distance between the third utility meter and the second transformer as determined from non-electrical data;
obtaining third electrical measurements from the third utility meter at third predetermined time intervals;
obtaining fourth electrical measurements from a fourth utility meter at the third predetermined time intervals;
determining a second likelihood that the third utility meter is fed by the second transformer by, at least, performing a time-based correlation between the third electrical measurements and the fourth electrical measurements within a predefined time window; and
responsive to the second likelihood exceeding the likelihood, associating a fourth load supplied through the fourth utility meter with the second transformer in the computer model of the electrical power distribution network.

18. The system of claim 11, wherein the predetermined time intervals comprise a first duration of a measurement duration, wherein the measurement duration exceeds the first duration.

19. The system of claim 11, wherein the first utility meter is an AMI meter.

20. One or more non-transitory computer-readable storage media storing instructions that when executed by one or more computers cause the one or more computers to perform operations comprising:
determining that a first utility meter is fed by a transformer in an electrical power distribution network based on a distance between the first utility meter and the transformer as determined from non-electrical data;
obtaining first electrical measurements from the first utility meter at predetermined time intervals;
obtaining second electrical measurements from a second utility meter at the predetermined time intervals;
determining a likelihood that the second utility meter is fed by the transformer by, at least, performing a time-based correlation between the first electrical measurements and the second electrical measurements within a predefined time window; and
associating a load supplied through the second utility meter with the transformer in a computer model of the electrical power distribution network.
